(19) United States
(12) Patent Application Publication
(10) Pub. No.: US 2024/0334896 A1
(43) Pub. Date: Oct. 10, 2024

(54) PET LAVATORY

(71) Applicant: Teresa Lynn White, Prosser, WA (US)

(72) Inventor: Teresa Lynn White, Prosser, WA (US)

(21) Appl. No.: 18/130,995

(22) Filed: Apr. 5, 2023

(51) Int. Cl. A01K 1/01

(52) U.S. Cl. CPC A01K 1/011

(57) ABSTRACT

The present disclosure relates to a pet lavatory. The pet lavatory includes a base element, a decorative element, a water receiving tank, a flushing system and a water flushing passage ring. The decorative element has an external design that is attractive to pet animals. The pet lavatory further includes a drain that extends though the base element to allow the excreted waste of pet for optimal flushing. The pet lavatory allows a pet to release their excreted materials without human intervention.

### TECHNICAL FIELD

The present invention relates to toilets, and more particularly, the present invention relates to a pet lavatory that comprises a water-flushing arrangement.

### BACKGROUND

Pet keeping involves taking care of the needs of pets such as pet grooming, pet vaccination, and pet waste management. Pet waste management requires the pet owner to potty train their pet so that their pet only excretes their waste in a desired location such as human toilets, places outside the home such as public parks, roadsides, bushes, and so on.

Pet waste management is often a difficult and time-consuming process for pet owners. Often, pets are difficult to be potty trained as communicating with pet animals is not an easy task due to the limited brain function of pets and the lack of spoken language for pets. Generally, pet animals excrete their waste such as stool, and urine in places such as but not limited to: public parks, rooms in homes, roadsides, and so on if the pet animal is not potty trained in an efficient manner. Often, male pet animals such as male dogs, and male cats excrete their waste on vertical structures in public places such as fire hydrants, trees, poles, and so on in an attempt to communicate with other pet animals or mark their territories.

Excretion (defecation) in public places by pet animals is a growing concern.

Defecation in public places creates a smell and an unhygienic atmosphere for people traveling in public places. Often pet animal owners carry pet waste cleaning/disposing off solutions such as but limited to plastic bags, plastic jugs and so on, and products such as pooper scoopers to clean their pet waste and dispose them off in a waste collection facility such as dustbin, sewerage pipe, landfill site and so on.

However, it is often not possible to carry the pet waste cleaning solutions in every public place in each scenario. If pet waste is not effectively cleaned, pet owners could face some punishment such as but not limited to: penalties in form of fines, prohibition from entering the public place, and so on according to public rules in some places/towns/countries.

Various other solutions exist in the prior art that addresses the problem of pet animal waste excretion. For instance, U.S. Pat. No. 20,110,146581A1 discloses an excretion disposal sheet for pet animals that contains fragrance adapted to develop aroma effectively masking the odor of excretion. The fragrance is in the form of a powder compound wherein the fragrance comprises cyclodextrin and this particulate compound is sandwiched between an upper surface of a core material and a liquid-pervious sheet in the form of tissue paper overlying the upper surface.

U.S. Pat. No. 5,129,365AA discloses a composition and method of absorbing animal dross. In one embodiment, the composition comprises discrete particles (about 50 microns to about 3350 microns, preferably about 600 microns to about 3350 microns in size) of a non-compacted water-swellable bentonite clay that effectively absorbs animal dross and simultaneously agglomerates into a sufficiently large and stable mass, thereby permitting physical separation of the soiled and wetted water-swellable bentonite clay particles from discrete particles of the unsoiled and unwetted water-swellable bentonite clay even after partial drying of about 1 to about 24 hours at room temperature, without substantial sticking to animal paws and fur. In another embodiment, the composition comprises discrete particles of a combination of non-compacted water-swellable sodium bentonite clay and calcium bentonite clay that effectively absorbs animal dross and simultaneously agglomerates into a water-dispersible but physically stable mass, thereby permitting physical separation of the soiled and wetted bentonite clay particles from discrete particles of the unsoiled and unwetted water-swellable bentonite clay, and has sufficient water-dispersibility for disposal through a household plumbing or sewer conduit without clogging.

The prior art solutions related to pet animal waste excretion do not provide a comfortable feeling to pets, have design flaws, are uneconomical, impractical, require human intervention, and are complex in nature. There is a need for an effective and efficient solution that solves the aforementioned problems of existing prior art solutions by providing a pet lavatory that comprises a water-flushing arrangement. Thus, a new pet lavatory is proposed that solves the aforementioned problems of existing prior art solutions.

### SUMMARY

While the way that the present disclosure addresses the disadvantages of the prior art will be discussed in greater detail below, in general, the present disclosure provides a pet lavatory that provides a comfortable feeling to pets for excreting.

The present disclosure overcomes the drawbacks of the existing devices by providing a pet lavatory, comprising: a base element comprising a top surface, a bottom surface; and a cavity formed in the top surface; wherein the cavity further comprises a drain that extends through the bottom surface. The pet lavatory further comprises a decorative element substantially positioned above the drain, wherein the decorative element is configured to attract a pet animal for excretion; and wherein the decorative element comprises an inbuilt flush tank. The pet lavatory further comprises a water receiving tank configured for receiving flushing water supplied by the inbuilt flush tank; and a water flushing passage ring connected to the water receiving tank. The water flushing passage ring further comprises a plurality of nozzles disposed along the inner circumference of the water flushing passage ring to direct high-pressure water towards the cavity to effectively clean the excreted material of the pet animals.

In an embodiment, the top surface comprises an overlying element that projects further from the water-flushing passage ring such that the water-flushing passage ring is at least substantially positioned below the overlying element.

In an embodiment, the top surface comprises a supporting surface such that the drain is positioned substantially below the supporting surface.

In an embodiment, the drain comprises a horizontal opening.

In an embodiment, the top surface and/or the cavity and/or sidewalls include a design feature for providing a natural feel to the pet.

In an embodiment, a tank bowl gasket is positioned between the water receiving tank and an extension element of the decorative element.

In an embodiment, a clamping assembly is configured to removably connect the decorative element with the water receiving tank, wherein the clamping assembly comprises at least one of a pair of toggle clamps, L-shaped clamp elements.

In an embodiment, an automatic toilet flushing sensing unit is configured to communicate with an automatic flush element of the inbuilt flush tank, wherein the automatic toilet flushing sensing unit is configured to initiate automatic flushing of excreted materials of pet.

In an embodiment, the decorative element has an external design resembling the group comprising of a fire hydrant, street light, electric pole, car tyre, wooden log, fence, bush, tree, and cactus.

In an embodiment, the inbuilt flush tank comprises an automatic flush element to provide automatic flushing action.

Embodiments of the present invention further disclose a pet lavatory comprising: a base element comprising a top surface, a bottom surface, and a cavity formed in the top surface; wherein the cavity further comprises a drain that extends through the bottom surface. The pet lavatory further comprises a decorative element substantially positioned above the drain; wherein the decorative element is configured to attract a pet animal for excretion. The pet lavatory further comprises a tank-less toilet flushing system configured to provide flushing water, a water receiving tank configured for receiving flushing water supplied by the tank-less toilet flushing system. The water flushing passage ring connected to the water receiving tank. The water flushing passage ring further comprises a plurality of nozzles disposed along the inner circumference of the water flushing passage ring to direct high pressure water towards the cavity to effectively clean the excreted material of pet animal.

### BRIEF DESCRIPTION OF THE DRAWINGS

A more complete understanding of the present disclosure may be derived by referring to the detailed description and claims when considered in connection with the Figures, wherein like reference numerals refer to similar elements throughout the Figures, and

FIG. 1 illustrates a first-front perspective view of a pet lavatory, according to an embodiment of the present invention.

FIG. 2 illustrates a second perspective view of the pet lavatory of FIG. 1, wherein the drain is shown removed for sake of simplicity.

FIG. 3 illustrates an exploded view of the pet lavatory of FIG. 1.

FIG. 4 illustrates a front perspective view of a drain of the pet lavatory of FIG. 1, according to an embodiment of the present invention.

FIG. 5 illustrates a schematic diagram of a decorative element including an inbuilt flush tank of the pet lavatory of FIG. 1, according to an embodiment of the present invention.

FIG. 6 illustrates a front perspective view of a pet lavatory wherein the drain is shown removed for sake of simplicity, according to another embodiment of the present invention.

FIG. 7 illustrates a front view of various decorative elements, according to various embodiments of the present invention.

FIG. 8 illustrates a pet lavatory of FIG. 1 being used by a pet animal.

FIG. 9 illustrates a front perspective view of a pet lavatory, according to yet another embodiment of the present invention.

FIG. 10 illustrates a pet lavatory of FIG. 9 being used by a pet animal.

### DETAILED DESCRIPTION

The following description is of exemplary embodiments of the invention only, and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms, and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

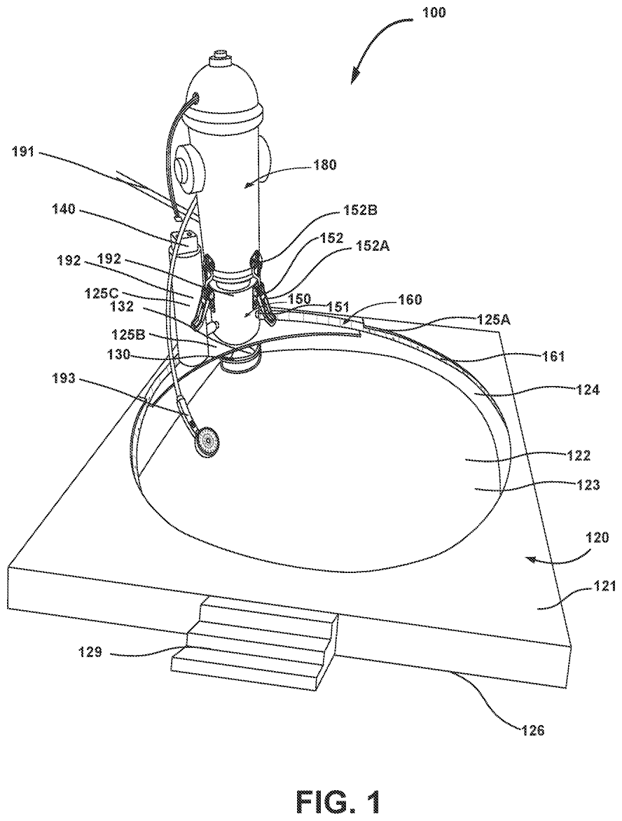

The pet lavatory will now be described with reference to the accompanying drawings, particularly FIGS. 1-10.

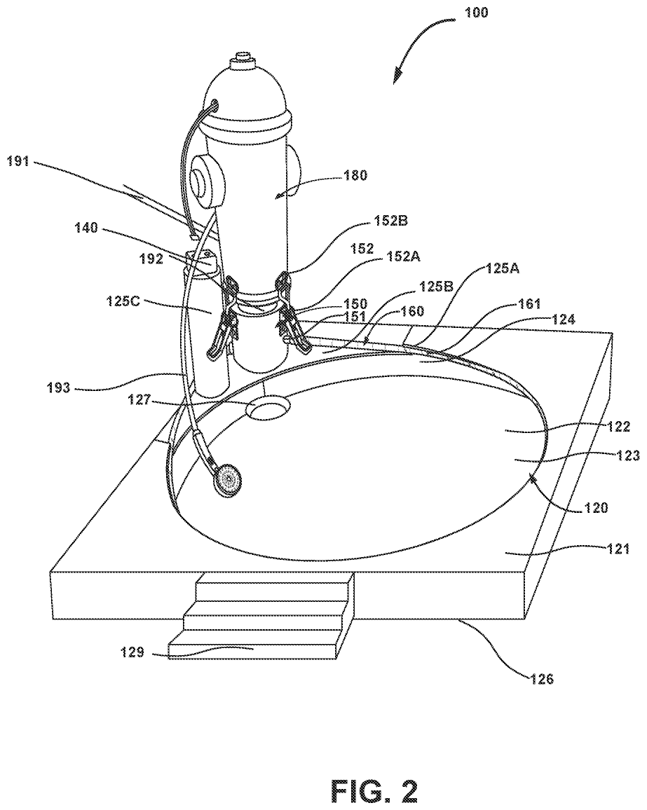

Reference is initially made to FIG. 1 which illustrates a front perspective view of a pet lavatory 100, according to an embodiment of the present invention. The pet lavatory 100 is configured for allowing a pet to release their excreted materials as but not limited to: stool, urine, vomit, blood, and so on without human intervention. As shown in FIGS. 1-2, the pet lavatory 100 comprises a base element 120, a water receiving tank 150, and a decorative element 180 with an inbuilt flush tank 190, the entirety of which will be described in greater detail in the below description.

Referring to FIGS. 1-4, the base element 120 is a quadrilateral shape in nature. The base element 120 comprises a top surface 121 and a bottom surface 126. A cavity 122 is formed in the top surface 121, wherein the cavity 122 is defined by a bottom surface 123 and a side surface 124. The cavity 122 could have any shape including but not limited to: circular shape, cuboid shape, oval shape, cubical shape, hemispherical shape, and so on. As seen in FIGS. 1-3, the cavity 122 has a circular shape. The top surface 121 comprises an overlying element 125A that projects further from a water-flushing passage ring 160 such that the water-flushing passage ring 160 is at least substantially positioned below the overlying element 125A. The overlying element 125A is configured to at least partially conceal the water-flushing passage ring 160 from pet eyes. The top surface 121 further comprises a supporting surface 125B that is configured to handle the weight (load) of the water receiving tank 150. The cavity 122 further comprises a circular interior tube-like drain 130 that extends through the bottom surface 126 to allow the excreted materials of the pet for optimal flushing. In an embodiment as seen in FIGS. 1-2, drain 130 is positioned substantially below the supporting surface 125B such that the drain 130 is at least partially concealed from the pet eyes. Thus, the supporting surface 125B further provides accidental protection from accidental falling of pets in the drain 130. The bottom surface 126 further comprises a drain hole 127 fluidly connected to an existing sewage line (not shown in figures). In an embodiment, the base element 120 further comprises a staircase 129 to provide access to the pet lavatory 100 to smaller pet animals.

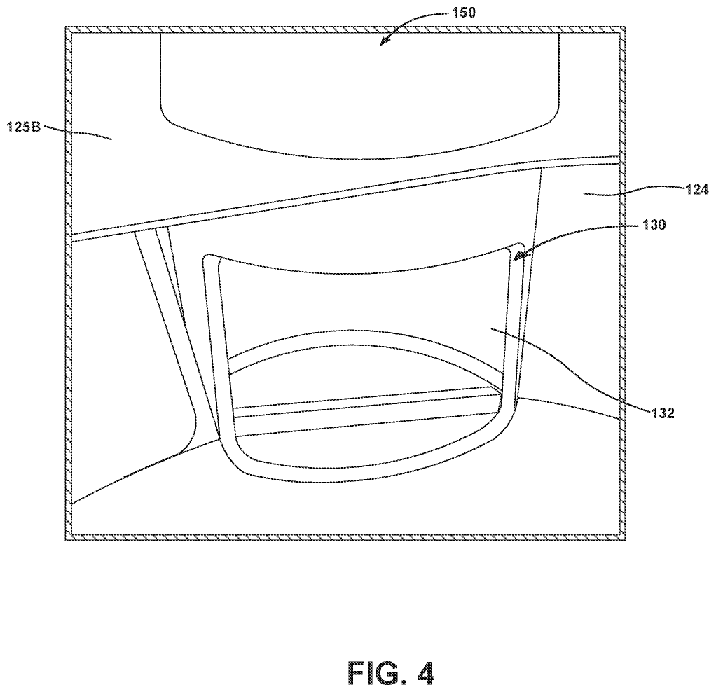

FIG. 4 illustrates a front view of drain 130 of the pet lavatory 100 of FIG. 1, according to an embodiment of the present invention. Referring to FIG. 4, the drain 130 comprises a horizontal opening 132 that is positioned below the supporting surface 125B such that the horizontal opening 132 is substantially concealed from the pet eyes due to configuration of the supporting surface 125B. Referring to FIGS. 1-4, the horizontal opening 132 is substantially parallel to the circumferential side surface 124. The cavity 122 as well as the supporting surface 125B has a downward slope towards the horizontal opening 132 to enable the excreted materials and/or water from discharging through the horizontal opening 132. Further, the drain 130 is fluidly connected to the drain hole 127 to enable the excreted materials and/or water to be discharged from the horizontal opening 132 of the drain hole 130 into an existing sewage line (not shown in figures).

Referring to FIGS. 1-4, the drain hole 127 of the bottom surface 126 comprises an elbow connector (not shown in figures) for enabling connection with the existing sewage line (not shown in figures) wherein the existing sewage line (not shown in figures) comprises a P-trap (not shown in figures) to trap noxious sewer gases from entering towards the pet lavatory 100.

In another embodiment (not shown in figures), the bottom surface 126 comprises a P-trap (not shown in figures) to trap noxious sewer gases from entering the pet lavatory 100.

In another embodiment, the top surface 121 as well as the cavity 122 could have a design feature (not shown in figures) such as wallpaper, artificial grass, and so on for providing a natural feel to the pet.

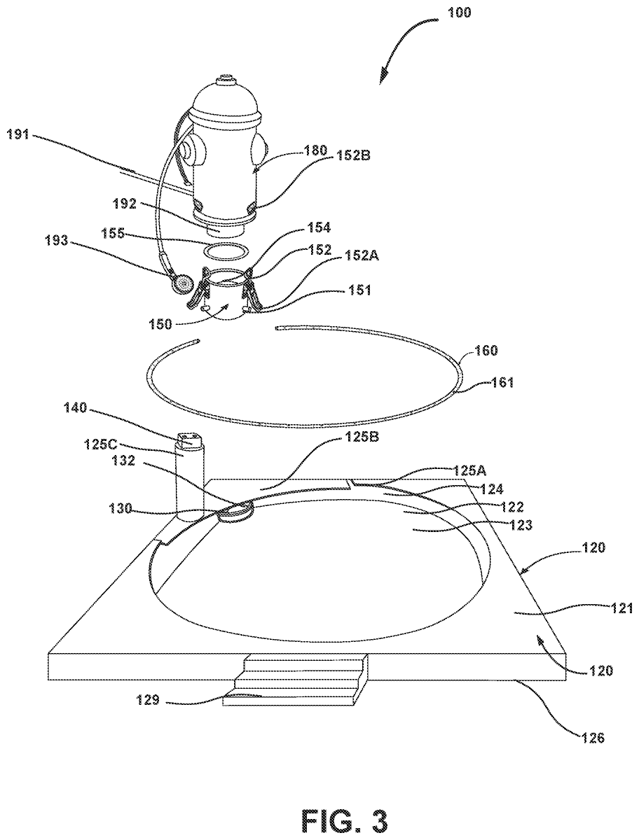

Referring to FIGS. 1-3, the water receiving tank 150 is configured for receiving flushing water supplied by the inbuilt flush tank 190 of the decorative element 180. A water flushing passage ring 160 is connected to a pair of outlet ports 151 of the water receiving tank 150, wherein the water flushing passage ring 160 is continuous loop shaped in nature. The water flushing passage ring 160 further comprises a plurality of nozzles 161. In an embodiment as seen in FIGS. 1-3, the plurality of nozzles 161 are disposed along the inner circumference of the water flushing passage ring 160. The plurality of nozzles 161 directs high-pressure flushing water towards the cavity 122 to effectively clean the excreted material. Further, the water receiving tank 150 comprises an end hole 154 that is configured to receive a tank bowl gasket 155 and/or an extension element 192 of the decorative element 180. The end hole 154 serves as a water inlet for the water receiving tank 150, and the end hole 154 further comprises a screw ring 154A to facilitate the connection of the water receiving tank 150 with the decorative element 180. The tank bowl gasket 155 creates a fluidic seal between the water receiving tank 150 and the decorative element 180. The tank bowl gasket 155 (FIG. 3) positioned between the water receiving tank 150 and an extension element 192 of the decorative element 180 creates a fluidic seal between the water receiving tank 150 and the decorative element 180.

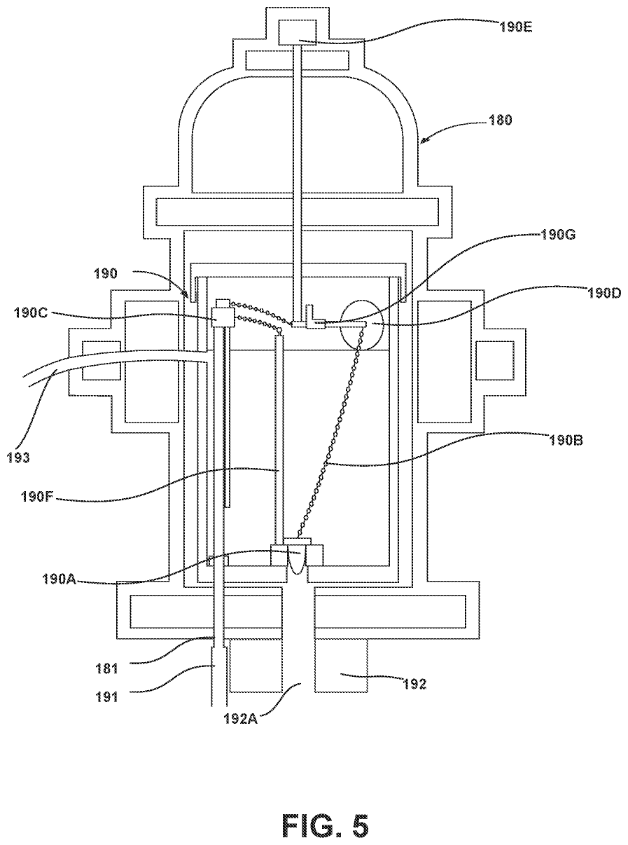

Referring to FIGS. 1-5, the decorative element 180 comprises an inbuilt flush tank 190 that further comprises an inlet supply water hose 191 fluidly connected to the household water supply and a sink sprayer hose 193 that is configured to clean areas of the pet lavatory 100 that are difficult to be cleaned by the water flushing passage ring 160. The sink sprayer hose 193 comprises essential parts/components such as but not limited to: sprayer head, sprayer button, sprayer handle, and so on to perform spray action of water. The decorative element 180 is configured to attract the pet for excretion. In an embodiment, as shown in FIG. 5, the decorative element 180 comprises an inbuilt flush tank 190 that is at least partially concealed within the decorative element 180. The inbuilt flush tank 190 is configured to hold a predetermined quantity of water and provide flushing action. The inbuilt flush tank 190 comprises a flapper flushing system that comprises a flapper valve 190A that is configured to be lifted to produce a suction effect, a chain 190B connected to the flapper valve 190A, a fill valve 190C configured to refill the inbuilt flush tank 190 after one flushing action, a filler float ball 190D configured to be lifted due to buoyancy effect and thereby shutting water supply after inbuilt flush tank 190 is filled, a manual handle 190E configured to be pressed to initiate manual flushing action and an overflow tube 190F configured to prevent water from overflowing by allowing water to pass through an outlet hole 192A. Further, the inbuilt flush tank 190 comprises an automatic flush element 190G that is configured to automatically displace the flapper valve 190A by pulling the chain 190B and thus, provide automatic flushing action. The inbuilt flush tank 190 comprises an inlet supply water hose 191 that fluidly connects the household water supply to the fill valve 190C, an outlet hole 192A that is fluidly connected to the water receiving tank 150, and a sink sprayer hose 193 that is configured to clean areas of the pet lavatory 100 that are difficult to be cleaned by the water flushing passage ring 160. The sink sprayer hose 193 is configured to direct high pressure water towards the difficult-to-clean areas of the pet lavatory 100. Further, the decorative element 180 comprises an inlet hole 181 for providing passage to the inlet supply water hose 191. The outlet hole 192A is formed in an extension element 192, wherein the extension element 192 is configured to engage against the end hole 154 (FIG. 3) of the water receiving tank 150. Further, the outlet hole 192A is configured to provide flushing water towards the end hole 154 (FIG. 3) of the water receiving tank 150.

Referring to FIGS. 1-3, a clamping assembly 152 is configured to removably connect the decorative element 180 with the water receiving tank 150. The water receiving tank 150 comprises a pair of clamp connector elements 152A and the decorative element 180 comprises a pair of corresponding clamp connector elements 152B wherein the pair of corresponding clamp connector elements 152B of the decorative element 180 engages against the pair of clamp connector elements 152A of the water receiving tank 150 to removably connect the water receiving tank 150 and the decorative element 180. In an embodiment as seen in FIGS. 1-3, the pair of clamp connector element 152A comprises a pair of toggle clamps disposed on opposite sides of the water receiving tank 150 and the pair of corresponding clamp connector elements 152B comprises a pair of toggle clamp engaging elements disposed on opposite sides of the decorative element 180.

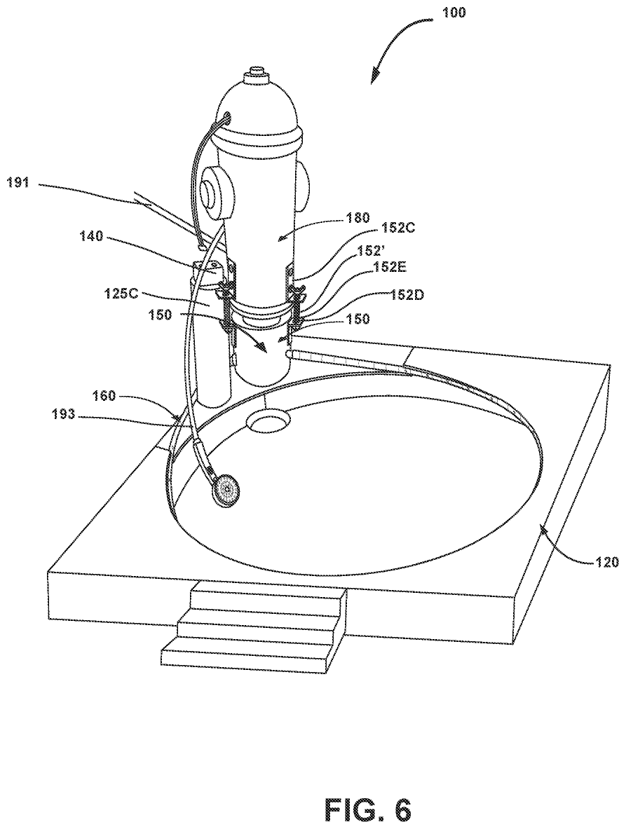

In another embodiment, as shown in FIG. 6, a clamping assembly 152′ is shown. The clamping assembly 152′ is configured to removably connect the decorative element 180 with the water receiving tank 150. The water receiving tank 150 comprises a pair of clamp connector elements 152C and the decorative element 180 comprises a pair of corresponding clamp connector elements 152D wherein the pair of corresponding clamp connector elements 152D of the decorative element 180 engages against the pair of clamp connector elements 152C of the water receiving tank 150 to removably connect the water receiving tank 150 and the decorative element 180. The pair of clamp connector element 152C comprises a pair of L-shaped clamp elements disposed on opposite sides of the water receiving tank 150 and the pair of corresponding clamp connector elements 152D comprises a pair of L-shaped clamp elements disposed on opposite sides of the decorative element 180. A nut and a bolt arrangement 152E effectively locks and unlocks the pair of L-shaped clamp elements disposed on opposite sides of the water receiving tank 150 relative to the pair of L-shaped clamp elements disposed on opposite sides of the decorative element 180 to thereby removably connect the water receiving tank 150 and the decorative element 180.

Referring to FIGS. 1-6, the pet lavatory 100 comprises an automatic toilet flushing sensing unit 140 that communicates with the automatic flush element 190G of the inbuilt flush tank 190. The automatic toilet flushing sensing unit 140 is configured such that a when pet enters inside the pet lavatory 100, wherein the automatic toilet flushing sensing unit 140 senses the presence of the pet, the pet excretes their waste, then afterward the pet exits the pet lavatory 100, and the automatic toilet flushing sensing unit 140 is set to a desired delay of time (seconds), and then the automatic flush element 190G is activated to initiate automatic flushing of excreted materials without human intervention. The automatic toilet flushing sensing unit 140 could utilize sensors such as but not limited to: optical sensors, infrared sensors, proximity sensors, LASER sensors, ultrasonic sensors and so on to detect the presence and absence of the pet animal. The communication between the automatic toilet flushing sensing unit 140 and the automatic flush element 190G could be in form of: wired communication involving wires/cables/optical fibers or wireless communication such as but not limited to: Bluetooth, ZIGBEE, WIFI, radio communication, internet, satellite communication and so on.

It should be understood that the automatic toilet flushing sensing unit 140 can be manually overridden by human pet owners by pressing the manual handle 190E. Thus, the pet lavatory 100 comprises a fail-safe system that allows a human pet owner to manually flush the excreted materials by pressing the manual handle 190E when the automatic toilet flushing sensing unit 140 has malfunctioned.

In an embodiment as shown in FIGS. 1-3, the automatic toilet flushing sensing unit 140 is placed on a stationary cylindrical platform 125C of the supporting surface 125B of the top surface 121.

In another embodiment (not shown in figures), the automatic toilet flushing sensing unit 140 is integrally formed (connected) in the decorative element 180. A hole 180A (not shown in figures) is formed in the outer periphery of the decorative element 180. The automatic toilet flushing sensing unit 140 is installed (placed) inside the hole 180A (not shown in figures) formed in the outer periphery of the decorative element 180.

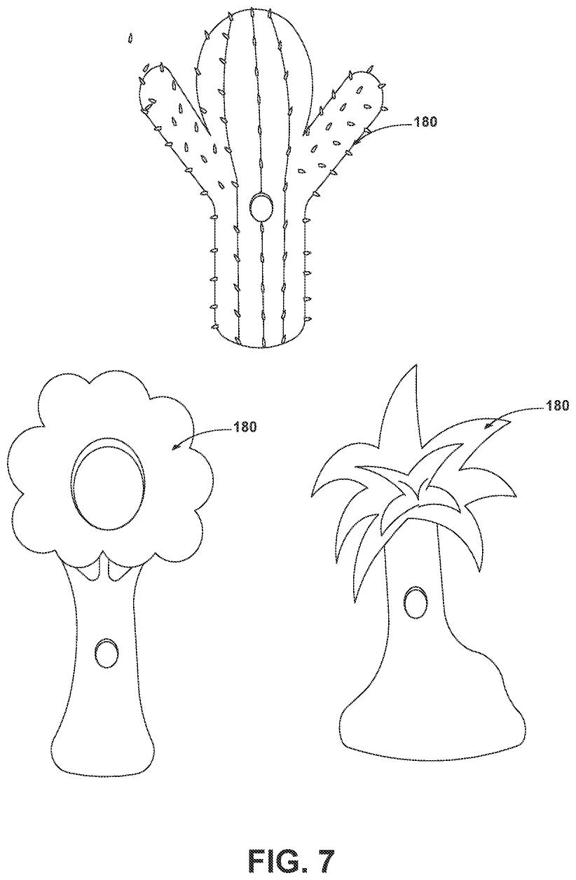

FIG. 7 illustrates a front view of various decorative elements 180, according to various embodiments of the present invention. As shown in FIG. 7, the decorative elements 180 could have external design resembling various trees such as palm tree and cactus. Further, it should be understood that the decorative elements 180 could have other external designs that are attractive to pet animals such as but not limited to street light, car tyre, electric pole, wooden log, fence, bush and so on. Further, it should be understood that the inbuilt flush tank 190 is configured to be installed within the decorative element 180 of various embodiments such that the size and/or shape of the inbuilt flush tank 190 is designed to be set smaller than the size and/or shape of the decorative element 180. Further, the decorative element 180 could be sprayed (rubbed) with urine or any other scent material to attract pet animals and thus facilitate pet animal potty training.

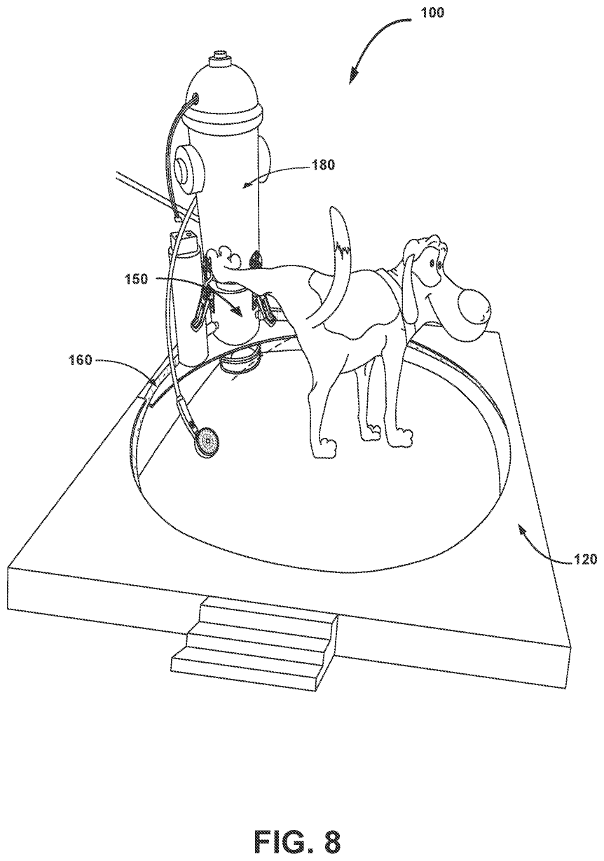

FIG. 8 illustrates a pet lavatory 100 being used by a pet animal wherein the pet animal is a dog. Further, the pet lavatory 100 could also be used by cats.

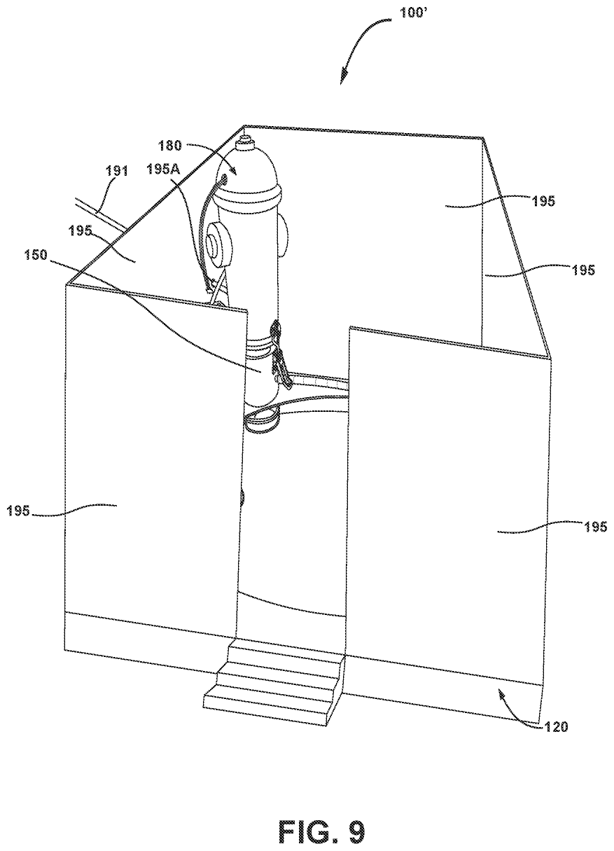

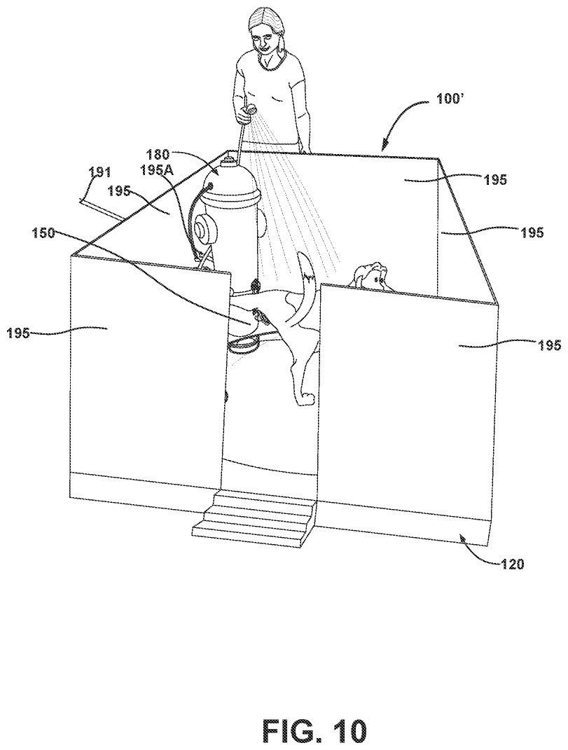

FIG. 9 illustrates a front perspective view of a pet lavatory 100′, according to yet another embodiment of the present invention. The pet lavatory 100′ is similar to the pet lavatory 100 of FIGS. 1-3 except for the addition of sidewalls. The plurality of sidewalls 195 is mounted on the periphery of the base element 120 and the plurality of sidewalls 195 serves the purpose of providing a substantially closed space (environment) for excretion. The plurality of sidewalls 195 could have a design feature (not shown in figures) such as wallpaper, artificial grass and so on for providing a natural feel to the pet. at least one sidewall 195 comprises a through hole 195A to allow the inlet supply water hose 191 to pass therethrough. As shown in FIG. 9, the number of sidewalls 195 is five and the staircase 129 is configured to provide access of the pet lavatory 100′ to smaller pet animals through an entrance defined by five sidewalls 195. FIG. 10 illustrates a pet lavatory 100′ being used by a pet animal wherein the pet animal is a dog. Further, the pet lavatory 100′ could also be used by pet animals such as cats.

In another embodiment (not shown in figures), a pet lavatory 200 (not shown in figures) will be described. The pet lavatory 200 (not shown in figures) is quite similar to the pet lavatory 100 shown in FIGS. 1-6 except for modifications associated with the decorative element. The pet lavatory 200 (not shown in figures) comprises a base element 120 similar to base element 120 of FIGS. 1-6, a water receiving tank 150 similar to water receiving tank 150 of FIGS. 1-6 and a distinct tank-less decorative element 280. The pet lavatory 200 (not shown in figures) is essentially (basically) a “tankless toilet”, and thus, the decorative element 280 (not shown in figures) does not hold a predetermined quantity of water.

The decorative element 280 (not shown in figures) is configured to attract the pet for excretion. The decorative element 280 (not shown in figures) comprises a bottom hole 281 (not shown in figures). The bottom hole 281 (not shown in figures) is configured to thereby allow the decorative element 280 (not shown in figures) to enclose (encompass) a tank-less toilet flushing system 290 (not shown in figures), a toilet spud 295 (not shown in figures) and a water receiving tank 150 described earlier in reference to FIGS. 1-10. The bottom hole 281 (not shown in figures) is removably sealed against the supporting surface 125B of the top surface 121 of the base element 120. The decorative element 280 (not shown in figures) could be detached from the supporting surface 125B for maintenance and/or replacement of either one of: the tank-less toilet flushing system 290 (not shown in figures), the toilet spud 295 (not shown in figures) and the water receiving tank 150. The decorative element 280 (not shown in figures) comprises a pair of side holes 282 to enable the connection of the water flushing passage ring 160 to the pair of outlet ports 151 of the water receiving tank 150. The decorative element 280 (not shown in figures) comprises a high-pressure inlet supply water hose 191 fluidly connected to the household water supply. The high-pressure inlet supply water hose 191 is further fluidly connected to tank-less toilet flushing system 290 (not shown in figures). The toilet spud 295 (not shown in figures) is connected to a screw ring 154A of the water receiving tank 150 to allow flushing water coming from the tank-less toilet flushing system 290 (not shown in figures) to the water receiving tank 150.

In an embodiment, the tank-less toilet flushing system 290 (not shown in figures) comprises a tank drain valve kit 290A (not shown in figures) with manually pressing dual flappers 290B (not shown in figures) to provide different amount of flushing water towards the toilet spud 295 (not shown in figures) depending on the type (solid feces, liquid urine) of excreted material of pet. Further, the decorative element 280 (not shown in figures) comprises an automatic flush element 290C (not shown in figures) that is configured to automatically and selectively operate either one of dual flappers 290B (not shown in figures) to provide automatic flushing action. It should be understood that the tankless toilet flushing system 290 (not shown in the figures) could utilize/use any existing flushing system already known in the art.

The pet lavatory 200 (not shown in figures) comprises an automatic toilet flushing sensing unit 140, earlier described in reference to FIGS. 1-10 that communicates with the automatic flush element 290C (not shown in figures) of the inbuilt flush tank 190.

It should be understood that the automatic toilet flushing sensing unit 140 can be manually overridden by human pet owner by pressing manually pressing dual flappers 290B (not shown in figures). Thus, the pet lavatory 100 comprises a fail-safe system that allows a human pet owner to manually flush the excreted materials by pressing the manually pressing dual flappers 290B (not shown in figures) when the automatic toilet flushing sensing unit 140 has malfunctioned.

In another embodiment, the base element 120 of the pet lavatory (100, 100′, 200) comprises a scrub brush hole (not shown in figures) for storing a scrub brush (not shown in figures) wherein the scrub brush (not shown in figures) is configured to be used in manually cleaning (scrubbing) the residual excreted materials from the base element 120. In another embodiment, the base element 120 of the pet lavatory (100, 100′, 200) comprises a sink sprayer hole (not shown in figures) to allow excreted materials to be cleaned using the sink sprayer hose 193.

It should be understood that the pet lavatory (100, 100′, 200) could be installed in residential/commercial property, and the pet lavatory (100, 100′, 200) could be used by various pets such as but not limited to: dogs, cats and so on. The design of the pet lavatory (100, 100′, 200) is a dry basin type, thus the pet lavatory (100, 100′, 200) may also be used as a pet shower. In addition, flushable cat/dog litter may be used to train cats/dogs to use the manual handle 190E of the inbuilt flush tank 190.

It should be understood that the materials involved in construction/assembly of the pet lavatory (100, 100′, 200) are selected for ease of cleaning, animal-friendliness, strength, and durability. Further, it should be understood that the pet lavatory (100, 100′, 200) is made up of substantially waterproof material to enable the pet lavatory (100, 100′, 200) to effectively function in moist environments. The materials involved in construction/assembly of the pet lavatory (100, 100′, 200) could include but not limited to: plastics, metals, ceramics, and so on. Further, it should be understood that the pet lavatory (100, 100′, 200) of the present invention is not limited to any particular size and shape. Further, it should be understood that the present invention is not limited to any construction/assembly methods. Broadly speaking, the pet lavatory (100, 100′, 200) could utilize/employ any construction/assembly methods such as but not limited to welding, screw-joining, riveting, and so on; shape such as cuboid, cylindrical, circular and so on; and size known in art.

The various components, and parts of the various embodiments of the pet lavatory (100, 100′, 200) of the present invention are similar and interchangeable. It is obvious to the one skilled in the art that the various components, and parts of the pet lavatory of one embodiment of the present invention could be considered for other embodiments with little or no variation. For instance, the various components, parts such as: base element 120, water receiving tank 150 of the pet lavatory 100 could be used for pet lavatory 200 with little variation.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A pet lavatory (100, 100′), comprising:
a base element (120) comprising a top surface (121), and a bottom surface (126);
a cavity (122) formed in the top surface (121), wherein the cavity (122) further comprises a drain (130) that extends through the bottom surface (126);
a decorative element (180) configured to attract a pet animal for excretion, wherein the decorative element (180) comprises an inbuilt flush tank (190);
a water receiving tank (150) configured for receiving flushing water supplied by the inbuilt flush tank (190), wherein the water receiving tank (150) is removably connected to the decorative element (180);
a water flushing passage ring (160) connected to the water receiving tank (150); and,
wherein the water flushing passage ring (160) further comprises a plurality of nozzles (161) to direct water towards the cavity (122) to effectively clean the excreted material of a pet animal.

2. The pet lavatory (100, 100′) according to claim 1, wherein the top surface (121) comprises an overlying element (125A) that projects further from the water flushing passage ring (160) such that the water flushing passage ring (160) is at least substantially positioned below the overlying element (125A).

3. The pet lavatory (100, 100′) according to claim 1, wherein the top surface (121) comprises a supporting surface (125B) such that the drain (130) is positioned substantially below the supporting surface (125B).

4. The pet lavatory (100, 100′) according to claim 1, wherein the drain (130) comprises a substantially horizontal opening (132).

5. The pet lavatory (100, 100′) according to claim 1, wherein the bottom surface (126) comprises an elbow connector for enabling connection with the sewage line.

6. The pet lavatory (100, 100′) according to claim 1, wherein the bottom surface (126) comprises a P-trap to trap noxious sewer gases from entering the pet lavatory (100, 100′).

7. The pet lavatory (100, 100′) according to claim 1, wherein the top surface (121) and/or the cavity (122) comprises a design feature for providing a natural feel to the pet.

8. The pet lavatory (100′) according to claim 1 further comprising a plurality of sidewalls (195) mounted on the periphery of the base element (120) for providing a substantially closed space for excretion.

9. The pet lavatory (100, 100′) according to claim 1, wherein the base element (120) further comprises a staircase (129) to provide access of the pet lavatory (100, 100′) to smaller pet animals.

10. The pet lavatory (100, 100′) according to claim 1 further comprising a tank bowl gasket (155) positioned between the water receiving tank (150) and an extension element (192) of the decorative element (180).

11. The pet lavatory (100, 100′) according to claim 1 further comprising a clamping assembly (152) configured to removably connect the decorative element (180) with the water receiving tank (150), wherein the clamping assembly (152) comprises at least one of: a pair of toggle clamps, a pair of L shaped clamp elements.

12. The pet lavatory (100, 100′) according to claim 1 further comprising an automatic toilet flushing sensing unit (140) configured to communicate with an automatic flush element (190G) of the inbuilt flush tank (190), wherein the automatic toilet flushing sensing unit (140) is configured to initiate automatic flushing of excreted materials of pet.

13. The pet lavatory (100, 100′) according to claim 12, wherein the automatic toilet flushing sensing unit (140) is integrally formed in the decorative element (180).

14. The pet lavatory (100, 100′) according to claim 1, wherein the decorative element (180) comprises an external design resembling from a group comprising of: a fire hydrant, a street light, an electric pole, a car tyre, a wooden log, a fence, a bush, a tree, a cactus.

15. The pet lavatory (100, 100′) according to claim 1, wherein the decorative element (180) comprises a sink sprayer hose (193) configured to clean areas of the pet lavatory (100, 100′) that are difficult to be cleaned by the water flushing passage ring (160).

16. The pet lavatory (100, 100′) according to claim 1, wherein the inbuilt flush tank (190) comprises an automatic flush element (190G) to provide automatic flushing action.

17. The pet lavatory (100, 100′) according to claim 1, wherein the plurality of nozzles (161) are disposed along the inner circumference of the water flushing passage ring (160).

18. The pet lavatory (100, 100′) according to claim 1, wherein the decorative element (180) is substantially positioned above the drain (130).

19. The pet lavatory (100, 100′) according to claim 1, wherein the cavity (122) has a shape selected from a group comprising of: circular shape, cuboid shape, oval shape, cubical shape and hemispherical shape.

20. A pet lavatory (200), comprising:
a base element (120) comprising a top surface (121), a bottom surface (126); a cavity (122) formed in the top surface (121); wherein the cavity (122) further comprises a drain (130) that extends through the bottom surface (126);
a decorative element (280) configured to attract a pet animal for excretion;
a tank-less toilet flushing system (290) configured to provide flushing water;
a water receiving tank (150) configured for receiving flushing water supplied by the tank-less toilet flushing system (290);
a water flushing passage ring (160) connected to the water receiving tank (150);
wherein the water flushing passage ring (160) further comprises a plurality of nozzles (161) to direct water towards the cavity (122) to effectively clean the excreted material of a pet animal.
